(19) United States
(12) Patent Application Publication
(10) Pub. No.: US 2014/0229011 A1
(43) Pub. Date: Aug. 14, 2014

(54) ELEVATOR APPARATUS AND ROPE SWAY SUPPRESSING METHOD THEREFOR

(71) Applicants: MITSUBISHI ELECTRIC RESEARCH LABORATORIES, INC., Cambridge, MA (US); MITSUBISHI ELECTRIC CORPORATION, Chiyoda-ku (JP)

(72) Inventors: Daiki FUKUI, Chiyoda-ku (JP); Seiji WATANABE, Chiyoda-ku (JP); Daisuke NAKAZAWA, Chiyoda-ku (JP); Mouhacine BENOSMAN, Cambridge, MA (US)

(73) Assignees: MITSUBISHI ELECTRIC RESEARCH LABORATORIES, INC., Cambridge, MA (US); MITSUBISHI ELECTRIC CORPORATION, Chiyoda-ku (JP)

(21) Appl. No.: 14/165,963

(22) Filed: Jan. 28, 2014

(30) Foreign Application Priority Data
Feb. 14, 2013 (JP) 2013-027002

(51) Int. Cl. B66B 7/10; G05B 15/02

(52) U.S. Cl. CPC B66B 7/10; G05B 15/02
USPC 700/275

(57) ABSTRACT

In an elevator apparatus, an actuating device applies a tension for suppressing a lateral vibration to a rope. A computation controller controls the actuating device by using lateral-vibration information of the rope as an input. Also, the computation controller selectively outputs, to the actuating device, a plurality of actuating commands including a first actuating command for applying the tension to the rope regardless of phase information of the lateral vibration of the rope and a second actuating command for applying a tension fluctuation for damping the lateral vibration to the rope based on the phase information.

### TECHNICAL FIELD

The present invention relates to an elevator apparatus and a rope sway suppressing method therefor, for suppressing a lateral vibration of a rope by appropriately controlling a tension of the rope when the lateral vibration of the rope occurs due to sway of a building, caused by, for example, an earthquake or a strong wind.

### BACKGROUND ART

In recent years, it is known that high-rise buildings continuously sway in short periods due to long-period seismic ground motions or a strong wind. In an elevator apparatus installed in such high-rise buildings, ropes such as a main rope, a governor rope, and a compensating rope resonate with the building sway to greatly sway. As a result, there occurs an event in which the ropes come into contact with equipment installed in a hoistway to be damaged or caught thereon. If the elevator apparatus continues travelling in the state described above, there is a fear in that the equipment breaks. As a result, there may arise a situation where passengers are trapped or long time is required for recovery.

Therefore, in a conventional elevator apparatus, when the lateral vibration (lateral sway) of compensating ropes exceeds a preset limit or the sway of a building exceeds a predetermined criterion, a tension of the compensating ropes is selectively changed by a tensioning mechanism to avoid a resonant condition (for example, see Patent Literature 1).

However, the method of simply increasing the tension of the ropes has a problem in that the increase in tension causes the ropes to have a natural frequency close to a natural frequency of the building to conversely increase the lateral vibration of the ropes.

Moreover, in another conventional elevator apparatus, the tension to be applied to the rope is changed in accordance with the position of a car (for example, see Patent Literature 2).

With the above-mentioned method, a region in which the natural frequency of the rope and the natural frequency of the building become close to each other can be reduced. However, the region in which the rope and the building resonate with each other cannot be eliminated. Therefore, there still is a possibility of occurrence of damage to the equipment and the entanglement of the ropes due to the resonance of the rope. Moreover, there is another problem in that the tension is required to be relatively greatly increased or reduced to suppress the lateral vibration of the rope by changing the natural frequency of the rope in the above-mentioned manner, which results in the need of a tensioning mechanism having a large capacity.

In regard to the problems described above, a further conventional elevator apparatus uses phase information of the lateral vibration of the rope to apply a tension fluctuation to the rope. As a result, greater damping effects than those in conventional cases can be obtained. Thus, both in the cases where the natural frequency of the rope becomes close to and equal to the natural frequency of the building, the lateral vibration of the rope can be reduced (for example, see Patent Literature 3).

### CITATION LIST

### Patent Literature

[Patent Literature 1] JP 10-279224 A

[Patent Literature 2] JP 2003-104656 A

[Patent Literature 3] WO 2010/013597

### SUMMARY OF THE INVENTION

### Problems to be Solved by the Invention

A general elevator apparatus uses a plurality of main ropes for suspending the car and tensions of the main ropes slightly differ from each other. When the tensions of the ropes arranged side by side differ from each other as described above, the ropes laterally vibrate in phases different from each other, particularly when the lateral vibration of the ropes are in a process of development.

Accordingly, the conventional rope sway suppressing method for applying the tension fluctuation to the ropes by using the phase information has a problem in that the phase information cannot be precisely acquired in the process of development of the lateral vibration of the ropes, and hence the sway of the ropes cannot be sufficiently suppressed.

The present invention has been made to solve the problems described above, and therefore has an object to provide an elevator apparatus and a rope sway suppressing method therefor, which are capable of more efficiently suppressing a lateral vibration of a rope.

### Means for Solving the Problem

According to an exemplary embodiment of the present invention, there is provided an elevator apparatus, comprising: an actuating device for applying a tension for suppressing a lateral vibration to a rope; and a computation controller for controlling the actuating device by using lateral-vibration information of the rope as an input. The computation controller selectively outputs, to the actuating device, a plurality of actuating commands including a first actuating command for applying the tension to the rope regardless of phase information of the lateral vibration of the rope and a second actuating command for applying a tension fluctuation for damping the lateral vibration to the rope based on the phase information.

In the elevator apparatus according to the present invention, the computation controller selectively outputs, to the actuating device, the plurality of actuating commands including the first actuating command for applying the tension to the rope regardless of the phase information of the lateral vibration of the rope and a second actuating command for applying the tension fluctuation for damping the lateral vibration to the rope based on the phase information. Therefore, in accordance with a process of the lateral vibration of the rope, the lateral vibration of the rope can be more effectively suppressed.

### BRIEF DESCRIPTION OF THE DRAWINGS

FIG. 1 is a configuration diagram illustrating an elevator apparatus according to a first embodiment of the present invention;

FIG. 2 is a block diagram illustrating a principal part of the elevator apparatus illustrated in FIG. 1;

FIG. 3 is a graph showing an example of a change in lateral vibration of main ropes or compensating ropes illustrated in FIG. 1 with time and an example of a change of an actuating command by a computation controller with time;

FIG. 4 is a plan view illustrating a first example of a first rope lateral-vibration sensor illustrated in FIG. 1;

FIG. 5 is a plan view illustrating a second example of the first rope lateral-vibration sensor illustrated in FIG. 1;

FIG. 6 is a graph showing a first example of a detection signal from the first rope lateral-vibration sensor illustrated in FIG. 4;

FIG. 7 is a graph showing a second example of the detection signal from the first rope lateral-vibration sensor illustrated in FIG. 4;

FIG. 8 is a plan view illustrating a third example of the first rope lateral-vibration sensor illustrated in FIG. 1;

FIG. 9 is a graph showing an example of a detection signal from the first rope lateral-vibration sensor illustrated in FIG. 8;

FIG. 10 is a graph showing a frequency response of a lateral-vibration waveform of the main ropes, obtained from the detection signal from the first rope lateral-vibration sensor illustrated in FIG. 8; and

FIG. 11 is a block diagram illustrating a principal part of an elevator apparatus according to a second embodiment of the present invention.

### MODES FOR CARRYING OUT THE INVENTION

In the following, modes for carrying out the present invention are described referring to the drawings.

### First Embodiment

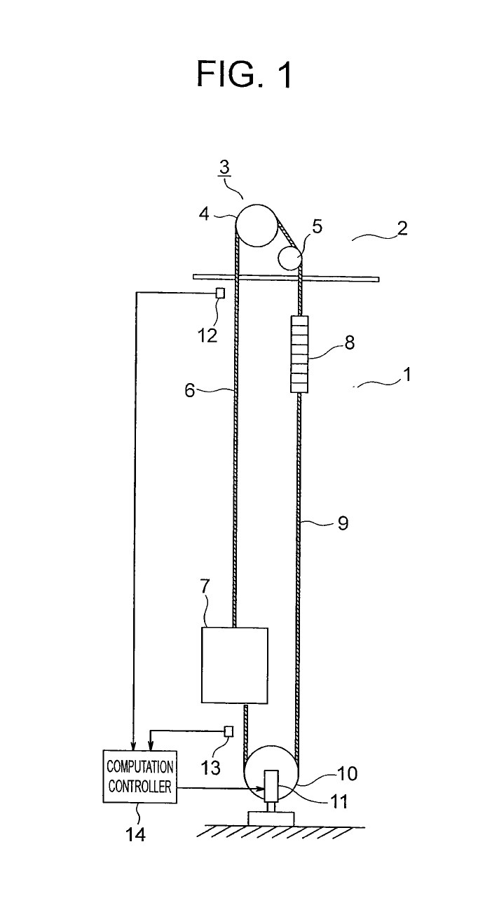

FIG. 1 is a configuration diagram illustrating an elevator apparatus according to a first embodiment of the present invention. In the drawing, a machine room 2 is provided in an upper part of a hoistway 1. A hoisting machine 3 is provided in the machine room 2. The hoisting machine 3 includes a driving sheave 4, a hoisting-machine motor (not shown) for rotating the driving sheave 4, and a hoisting-machine brake (not shown) for braking the rotation of the driving sheave 4. In the vicinity of the hoisting machine 3, a deflector sheave 5 is provided.

A plurality of (only one thereof is illustrated in FIG. 1) main ropes (suspension bodies) 6 are wound around the driving sheave 4 and the deflector sheave 5. The main ropes 6 are arranged side by side at intervals. A car 7 is connected to first end portions of the main ropes 6. A counterweight 8 is connected to second end portions of the main ropes 6. The car 7 and the counterweight 8 are suspended in the hoistway 1 by the main ropes 6 using 1:1 roping, and are raised and lowered by the hoisting machine 3.

Inside the hoistway 1, a pair of car guide rails (not shown) for guiding the raising and lowering of the car 7 and a pair of counterweight guide rails (not shown) for guiding the raising and lowering of the counterweight 8 are installed. A plurality of (only one thereof is illustrated in FIG. 1) compensating ropes 9 are suspended between the car 7 and the counterweight 8. The compensating ropes 9 are arranged side by side at intervals.

In a bottom part of the hoistway 1, a tension sheave 10 is provided, around which the compensating ropes 9 are wound. An actuating device (external-force applying device) 11 for displacing the tension sheave 10 in a vertical direction to adjust a tension of the main ropes 6 and the compensating ropes 9 is provided to the tension sheave 10. As the actuating device 11, for example, a hydraulic jack, an electric motor, or the like is used. When a lateral vibration occurs in the main ropes 6 and the compensating ropes 9, the actuating device 11 applies a tension for suppressing the lateral vibration to the main ropes 6 and the compensating ropes 9.

In the upper part of the hoistway 1, a first rope lateral-vibration sensor 12 for detecting the lateral vibration of the main ropes 6 is installed. In a lower part of the hoistway 1, a second rope lateral-vibration sensor 13 for detecting the lateral vibration of the compensating ropes 9 is installed. As the rope lateral-vibration sensors 12 and 13, non-contact displacement sensors are used.

Detection signals (lateral-vibration information) from the rope lateral-vibration sensors 12 and 13 are input to a computation controller 14. The computation controller 14 controls the actuating device 11 in accordance with the detection signals from the rope lateral-vibration sensors 12 and 13.

The computation controller 14 controls the actuating device 11 by a different control method in accordance with a state of the lateral vibration of the ropes (the main ropes 6 or the compensating ropes 9). Specifically, the computation controller 14 selectively outputs a plurality of actuating commands including a first actuating command and a second actuating command to the actuating device 11. The first actuating command is a command to apply the tension to the ropes regardless of the phase information of the lateral vibration of the ropes. The second actuating command is a command to apply a tension fluctuation for damping the lateral vibration to the ropes based on the phase information of the lateral vibration of the ropes.

Further, the second actuating command is, for example, a coefficient multiple of a function obtained by multiplying a displacement of the lateral vibration of the ropes by at least one of the displacement and a speed (for example, a coefficient multiple of the result obtained by multiplying the displacement of the lateral vibration of the ropes by the speed or a coefficient multiple of a square of the displacement of the lateral vibration of the ropes).

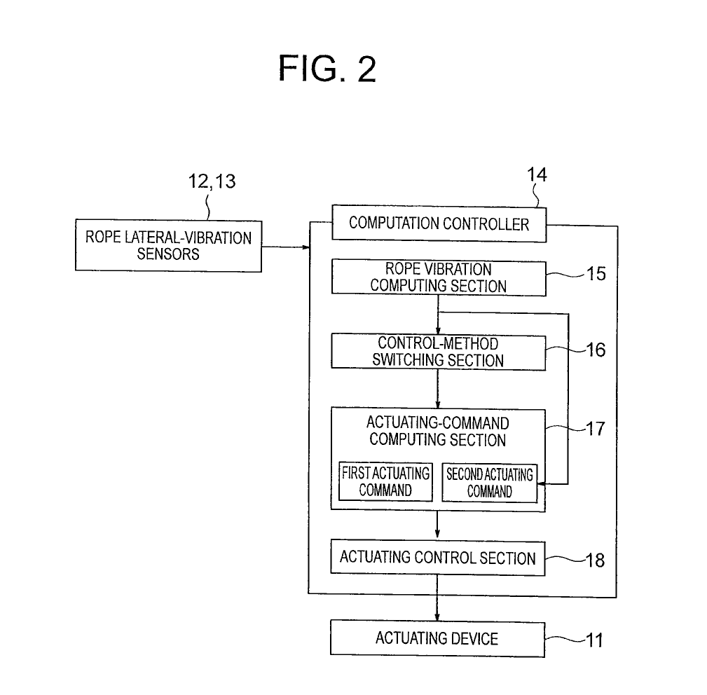

FIG. 2 is a block diagram illustrating a principal part of the elevator apparatus illustrated in FIG. 1. The computation controller 14 includes a rope vibration computing section 15, a control-method switching section 16, an actuating-command computing section 17, and an actuating control section 18. The rope vibration computing section 15 computes the lateral vibration of the main ropes 6 and the compensating ropes 9 based on the detection signals from the rope lateral-vibration sensors 12 and 13.

The control-method switching section 16 switches the actuating command to be output to the actuating device 11 in accordance with vibrating states of the main ropes 6 and the compensating ropes 9. The actuating-command computing section 17 computes the actuating command selected by the control-method switching section 16. The actuating control section 18 controls the actuating device 11 based on the actuating command obtained in the actuating-command computing section 17. The above-mentioned functions of the computation controller 14 can be realized by, for example, a microcomputer.

In this case, the control-method switching section 16 determines that the lateral vibration is in a process of development and the ropes vibrate in asynchronous with each other when an amplitude of the lateral vibration of the ropes (the main ropes 6 or the compensating ropes 9) is equal to or larger than a preset first amplitude threshold value and smaller than a second amplitude threshold value (first amplitude threshold value<second amplitude threshold value), and therefore selects the first actuating command. Then, when the amplitude become equal to or larger than the second amplitude threshold value, it is determined that all the ropes vibrate in synchronous with each other, and therefore the second actuating command is selected.

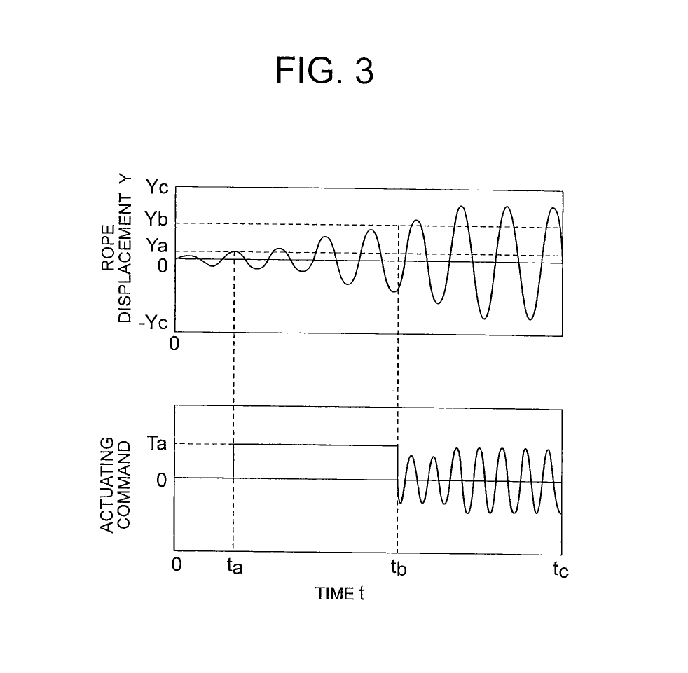

FIG. 3 is a graph showing an example of a change in lateral vibration of the main ropes 6 or the compensating ropes 9 illustrated in FIG. 1 with time and an example of a change of the actuating command by the computation controller 14 with time. In this example, when the amplitude of the ropes reaches a first amplitude threshold value Ya, the first actuating command is output to the actuating device 11 to apply a given tension to the ropes. Then, when the amplitude of the ropes reaches a second amplitude threshold value Yb, the second actuating command using the phase information is output to the actuating device 11 to apply a tension fluctuation for damping the lateral vibration to the ropes.

In the elevator apparatus described above, the computation controller 14 selectively outputs the first actuating command independent of the phase information of the lateral vibration of the ropes and the second actuating command using the phase information to the actuating device 11. Therefore, in accordance with the process of the lateral vibration of the ropes, the lateral vibration of the ropes can be more effectively suppressed.

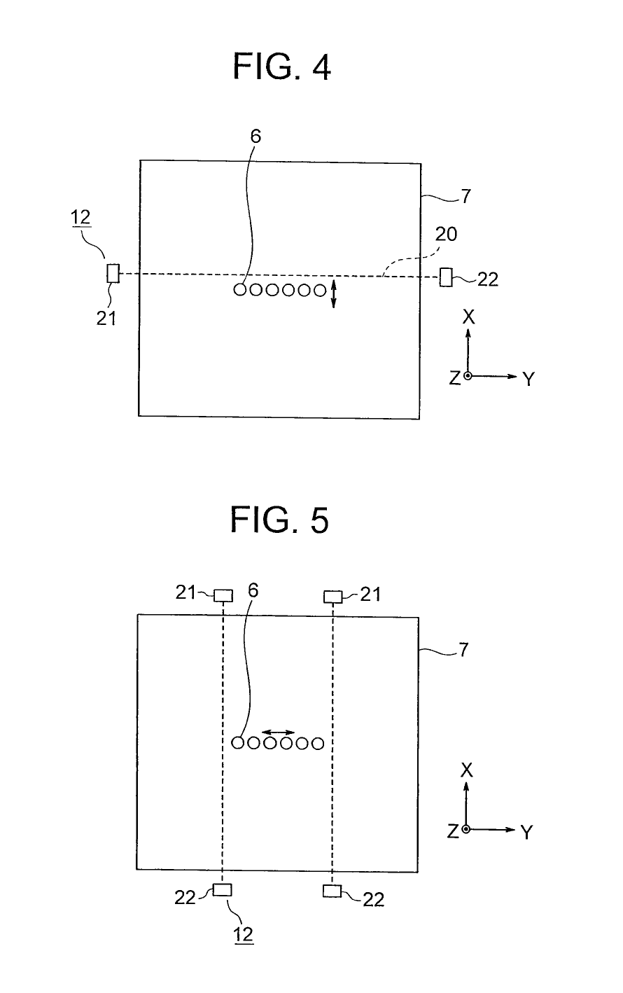

FIG. 4 is a plan view illustrating a first example of the first rope lateral-vibration sensor 12 illustrated in FIG. 1. In this example, the first rope lateral-vibration sensor 12 includes a projector 21 for projecting detection light 20 and a light receiver 22 for receiving the detection light 20. The projector 21 and the light receiver 22 are provided on both sides of the car 7 in a width direction (Y-axis direction of the drawing) as viewed from directly above. The detection light 20 is projected in a horizontal direction in parallel to the width direction of the car 7.

When the amplitude of the lateral vibration of the main ropes 6 in a front/back direction (X-axis direction of the drawing) of the car 7 reaches a preset amplitude threshold value, the detection light 20 is blocked. Specifically, in this example, an intermittent ON/OFF signal is output in accordance with the lateral vibration of the main ropes 6. When the two amplitude threshold values are set as described above, two sets of the projectors 21 and the light receivers 22 are provided so that distances from the main ropes 6 to the detection light 20 are different from each other.

FIG. 5 is a plan view illustrating a second example of the first rope lateral-vibration sensor 12 illustrated in FIG. 1. In the second example, the two projectors 21 and the two light receivers 22 are provided on both sides of the car 7 in the front/back direction as viewed from directly above so as to detect the lateral vibration of the main ropes 6 in the width direction of the car 7. When the plurality of main ropes 6 are horizontally arranged side by side, distances between the respective main ropes 6 and the first rope lateral-vibration sensor 12 differ from each other. Therefore, the lateral-vibration states of all the main ropes 6 cannot be detected for some amplitude of the lateral vibration of the main ropes 6. However, by detecting the main ropes 6 by the first rope lateral-vibration sensor 12 provided on both ends, the number of detectable main ropes 6 can be increased.

In the manner described above, the amount of lateral-vibration information of the main ropes 6 can be increased. As a result, the vibrating states of the plurality of main ropes 6 can be determined with good accuracy.

Although the example where the first rope lateral-vibration sensor 12 is provided for the main ropes 6 arranged on both ends has been described, the first rope lateral-vibration sensor 12 may be provided only for the main rope 6 provided on one end. Further, there may be provided such a configuration that the number of first rope lateral-vibration sensors 12 is increased by providing the first rope lateral-vibration sensor 12 also for the main ropes 6 arranged near the center so as to further increase the amount of lateral-vibration information.

Even in the case illustrated in FIG. 5, when two amplitude threshold values are to be set, four sets of the projectors 21 and the light-receivers 22 may be arranged. Further, by combining FIGS. 4 and 5, the lateral vibration both in the width direction and the front/back direction of the car 7 can be detected. Further, the second rope lateral-vibration sensor 13 can be configured in the same manner as the first rope lateral-vibration sensor 12.

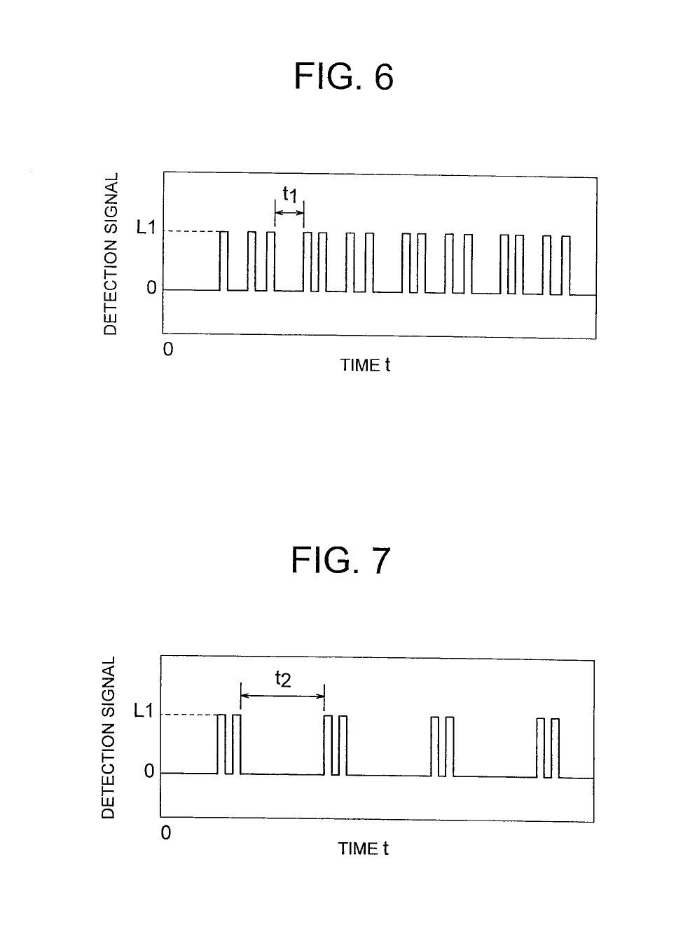

FIG. 6 is a graph showing a first example of the detection signal from the first rope lateral-vibration sensor 12 illustrated in FIG. 4, whereas FIG. 7 is a graph showing a second example of the detection signal from the first rope lateral-vibration sensor 12 illustrated in FIG. 4. When the detection light 20 is blocked by the main ropes 6, the detection signal rises to L1. Specifically, the lateral-vibration information of the main ropes 6 is an ON/OFF signal output in accordance with the lateral vibration of the main ropes 6.

In the case where the simple ON/OFF sensor as illustrated in FIG. 4 is used as the first rope lateral-vibration sensor 12, when the lateral vibrations of the individual main ropes 6 are not synchronous with each other, as shown in FIG. 6, timing of outputting the signal indicating the detection of the lateral vibration varies. As a result, there is no correlation between a time difference t1 corresponding to an output interval and a period.

On the other hand, when the lateral vibrations of all the main ropes 6 are synchronous with each other, as shown in FIG. 7, the outputs from the sensor appear as a group, and thus a time difference t2 to a next output corresponds to a period. Therefore, it can be determined whether or not the lateral vibrations of the main ropes 6 are synchronous with each other based on the time difference between the signals, each indicating the detection of the lateral vibration, so as to switch the actuating command.

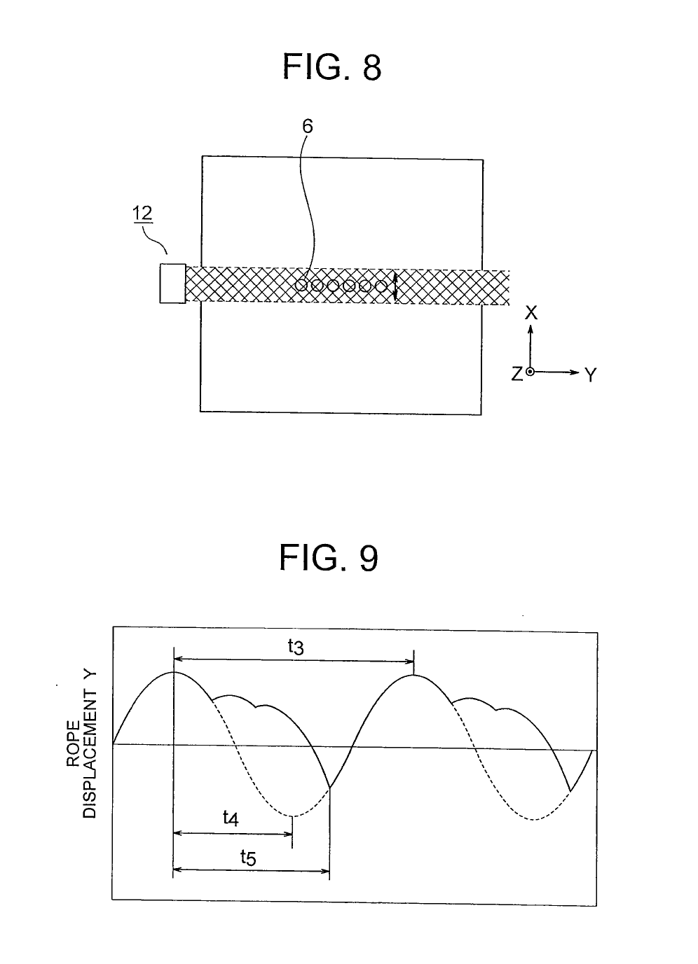

FIG. 8 is a plan view illustrating a third example of the first rope lateral-vibration sensor 12 illustrated in FIG. 1. In the third example, a laser sensor is used as the first rope lateral-vibration sensor 12. In this case, the first rope lateral-vibration sensor 12 emits a laser beam having a predetermined width in the horizontal direction in parallel to the width direction of the car 7. With the first rope lateral-vibration sensor 12 described above, the lateral vibration of the main ropes 6 can be continuously measured.

Further, by the combination with a pair of the laser sensors provided for emitting laser beams in parallel to the front/back direction of the car 7 toward the main ropes 6 provided on both ends, the lateral vibration in both the width direction and the front/back direction of the car 7 can be continuously measured. Moreover, the second rope lateral-vibration sensor 13 can be configured in the same manner as the first rope lateral-vibration sensor 12.

FIG. 9 is a graph showing an example of the detection signal from the first rope lateral-vibration sensor 12 illustrated in FIG. 8. In the case where the lateral-vibration information is the signal obtained by continuously measuring the lateral vibration of the main ropes 6, when the lateral vibrations of all the main ropes 6 are synchronous with each other, the sensor output is measured as substantially one waveform (sine wave). In this case, time t3 between the maximum amplitudes corresponds to one period, and a time difference t4 between the maximum amplitude and a minimum amplitude is a half period.

On the other hand, when the lateral vibrations of the individual main ropes 6 are not synchronous with each other, the waveform follows the maximum amplitudes of the main ropes 6 having different phases. Therefore, the waveform is distorted as a whole. In this case, a time difference t5 between the maximum amplitude and the minimum amplitude is different from t4. Therefore, it can be determined whether the lateral vibrations are synchronous or asynchronous based on the above-mentioned value so as to switch the actuating command.

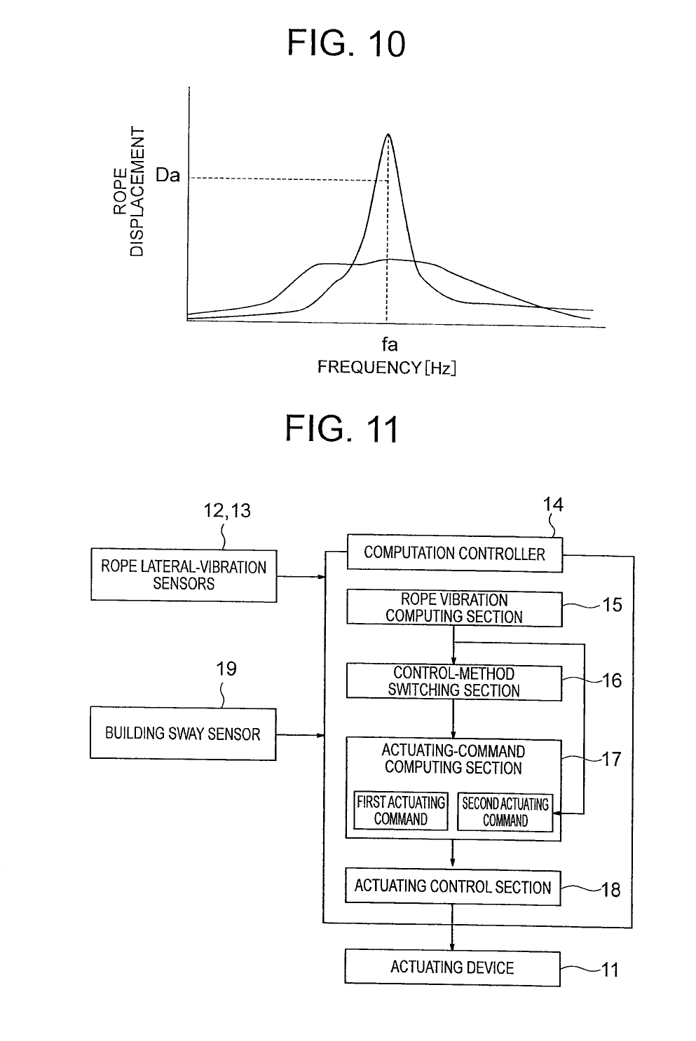

FIG. 10 is a graph showing a frequency response of the lateral-vibration waveforms of the main ropes 6, obtained from the detection signal from the first rope lateral-vibration sensor 12 illustrated in FIG. 8. As illustrated in FIG. 8, when the lateral vibration of the main ropes 6 is to be continuously measured, the frequency response of the lateral-vibration waveform of the main ropes 6 may be computed so as to determine whether the lateral vibrations are synchronous or asynchronous, based on a height of a peak.

Specifically, when the lateral vibrations of all the main ropes 6 are synchronous with each other, a characteristic becomes close to a single period. Therefore, the characteristic has a high peak at a frequency fa. Accordingly, when the peak value is higher than a preset peak threshold value Da, it can be determined that the lateral vibrations of all the main ropes 6 are synchronous with each other. The frequency fa may be a value calculated in advance or a value determined from the time t3 described above.

On the other hand, when the lateral vibrations of the individual main ropes 6 are not synchronous with each other, the frequency characteristic has a wide bandwidth. Therefore, it can be determined that the lateral vibrations are asynchronous.

Even by performing the switching between the first actuating command and the second actuating command based on the result of determination of synchronization as described above, the lateral vibration of the ropes can be more efficiently suppressed in accordance with the process of the lateral vibration of the ropes.

### Second Embodiment

Next, FIG. 11 is a block diagram illustrating a principal part of an elevator apparatus according to a second embodiment of the present invention. The computation controller 14 uses a signal from at least one building sway sensor 19 as an input, and outputs the first actuating command to the actuating device 11 when sway of a building equal to or larger than a preset building sway threshold value is detected. The computation controller 14 also outputs the second actuating command to the actuating device 11 when the amplitude of the lateral vibration of the ropes (main ropes 6 or compensating ropes 9) becomes equal to or larger than the preset amplitude threshold value. The rest of the configuration is similar or identical to that of the first embodiment.

As described above, even by performing the switching between the first actuating command and the second actuating command not only based on the lateral-vibration information of the ropes but also on information of the building sway, the lateral vibration of the ropes can be more efficiently suppressed.

Note that, the number and the position of the rope lateral-vibration sensor are not limited to those described in the above-mentioned examples. For example, the rope lateral-vibration sensors may be provided on the car side and the counterweight side in the middle of the hoistway.

Further, the first actuating command is not limited to a command to apply the given tension. For example, the tension to be applied may be changed in accordance with vibration information such as the maximum amplitude or position information of the car.

Yet further, each of the ropes may be a general rope having a circular cross section or a rope having a flattened cross section, that is, a belt.

Still further, the present invention is also applicable to a rope other than the main rope and the compensating rope, such as, for example, a governor rope. Further, the present invention is also applicable to a control cable used for power feeding, which is suspended from the car. Specifically, the control cable is included in the ropes used in the present invention.

Although the elevator apparatus using 1:1 roping is illustrated in FIG. 1, the roping method is not particularly limited. For example, 2:1 roping may be used.

Further, the layout of equipment is not limited to that illustrated in FIG. 1. For example, the number and the position of the hoisting machine are not particularly limited.

Yet further, the present invention is applicable to all types of elevator apparatus such as a machine room-less elevator, a double-deck elevator, and a one-shaft multi-car system elevator.

### REFERENCE SIGNS LIST

6 main rope, 9 compensating rope, 11 actuating device, 12 first rope lateral-vibration sensor, 13 second rope lateral-vibration sensor, 14 computation controller, 19 building sway sensor

1. An elevator apparatus, comprising:
an actuating device for applying a tension for suppressing a lateral vibration to a rope; and
a computation controller for controlling the actuating device by using lateral-vibration information of the rope as an input,
wherein the computation controller selectively outputs, to the actuating device, a plurality of actuating commands including a first actuating command for applying the tension to the rope regardless of phase information of the lateral vibration of the rope and a second actuating command for applying a tension fluctuation for damping the lateral vibration to the rope based on the phase information.

2. An elevator apparatus according to claim 1, wherein the computation controller outputs the first actuating command to the actuating device when an amplitude of the lateral vibration of the rope is smaller than a preset amplitude threshold value and outputs the second actuating command to the actuating device when the amplitude becomes equal to or larger than the amplitude threshold value.

3. An elevator apparatus according to claim 1, wherein:
the rope comprises at least two ropes arranged side by side; and
the computation controller determines whether or not the lateral vibrations of the ropes are synchronous with each other to output the first actuating command to the actuating device when the lateral vibrations of the ropes are asynchronous with each other and output the second actuating command to the actuating device when the lateral vibrations of the ropes are synchronous with each other.

4. An elevator apparatus according to claim 3, wherein:
the lateral-vibration information of the rope is an ON/OFF signal output in accordance with the lateral vibrations of the ropes; and
the computation controller determines whether or not the lateral vibrations of the ropes are synchronous with each other, based on a time difference between signals indicating detection of the lateral vibrations of the ropes.

5. An elevator apparatus according to claim 3, wherein:
the lateral-vibration information of the rope is a signal obtained by continuously measuring the lateral vibrations of the ropes; and
the computation controller determines whether or not the lateral vibrations of the ropes are synchronous with each other, based on time between maximum amplitudes of the lateral vibrations of the ropes and a time difference between the maximum amplitude and a minimum amplitude.

6. An elevator apparatus according to claim 3, wherein:
the lateral-vibration information of the rope is a signal obtained by continuously measuring the lateral vibrations of the ropes; and
the computation controller computes a frequency response of a lateral-vibration waveform of the ropes, and determines whether or not the lateral vibrations of the ropes are synchronous with each other, based on a height of a peak.

7. An elevator apparatus according to claim 1, wherein the computation controller uses a signal from a building sway sensor as an input to output the first actuating command to the actuating device when sway of a building equal to or larger than a preset building sway threshold value is detected, and to output the second actuating command to the actuating device when an amplitude of the lateral vibration of the rope becomes equal to or larger than a preset amplitude threshold value.

8. A rope sway suppressing method for an elevator apparatus, for applying a tension to a rope by an actuating device to suppress a lateral vibration of the rope, the rope sway suppressing method comprising:
applying the tension to the rope regardless of phase information of the lateral vibration of the rope when an amplitude of the lateral vibration of the rope is smaller than a preset amplitude threshold value; and
applying a tension fluctuation for damping the lateral vibration to the rope based on the phase information when the amplitude becomes equal to or larger than the amplitude threshold value.

9. A rope sway suppressing method for an elevator apparatus, for applying a tension to a plurality of ropes arranged side by side by an actuating device to suppress lateral vibrations of the ropes, comprising:
determining whether or not the lateral vibrations of the ropes are synchronous with each other to apply the tension to the ropes regardless of phase information of the lateral vibrations of the ropes when the lateral vibrations of the ropes are asynchronous with each other, and to apply a tension fluctuation for damping the lateral vibrations to the ropes based on the phase information when the lateral vibrations of the ropes are synchronous with each other.

10. A rope sway suppressing method for an elevator apparatus, for applying a tension to a rope by an actuating device to suppress a lateral vibration of the rope, the rope sway suppressing method comprising:
applying the tension to the rope regardless of phase information of the lateral vibration of the rope when sway of a building equal to or larger than a preset building sway threshold value is detected; and
applying a tension fluctuation for damping the lateral vibration to the rope based on the phase information when an amplitude of the lateral vibration of the rope becomes equal to or larger than a preset amplitude threshold value.
